(19) United States
(12) Patent Application Publication
(10) Pub. No.: US 2014/0123821 A1
(43) Pub. Date: May 8, 2014

(54) Process of manufacturing drive shaft of an explosion-proof motor

(71) Applicant: NINGBO ZHENMING SHAFT CO., LTD., Ningbo (CN)

(72) Inventor: Le Le, Ningbo (CN)

(73) Assignee: Ningbo Zhenming Shaft Co., Ltd., Ningbo (CN)

(21) Appl. No.: 13/786,491

(22) Filed: Mar. 6, 2013

(30) Foreign Application Priority Data
Nov. 5, 2012 (CN) 201210437103.5

(51) Int. Cl. B23B 1/00

(52) U.S. Cl. CPC B23B 1/00
USPC 82/1.11

(57) ABSTRACT

A process of manufacturing a drive shaft of an explosion-proof motor, the drive shaft having a cylindrical section and a spline section, the process includes the steps of horizontally disposing the drive shaft; continuously forward moving the drive shaft; feeding both a milling cutter and a correction roller toward the drive shaft wherein the correction roller is coaxial with a shaft of a lathe; activating the milling cutter to mill a front end of the drive shaft; and activating the correction roller to correct any deformations generated by the milling. The correction roller is made of diamond. The cylindrical section has a deformation of less than 0.02 mm per 200 mm of length, and the spline section has a deformation of less than 0.02 mm per 250 mm of length.

### BACKGROUND OF THE INVENTION

1. Field of the Invention

The invention relates to explosion-proof electric motors and more particularly to a process of manufacturing a drive shaft of an explosion-proof motor.

2. Description of Related Art

Explosion-proof motors are widely used in hazardous environments such as coal mines, petroleum and natural gas industries, petrochemical industry, and chemical industry because they do not generate spark in operation. Further, explosion-proof motors widely used in textile industry, metallurgy, urban gas supply, transportation, food processing, paper manufacture, and medicine. Drive shaft, as the essential part of an explosion-proof motor, plays a big role in the normal operation of the explosion-proof motor. The drive shaft is comprised of a cylindrical section and a spline section which is formed by milling or roll cutting.

The conventional drive shaft of an explosion-proof motor has the following disadvantages including being subject to bending or deformation, being difficult of manufacturing, being subject to break in a diameter reduction section, insufficient resistance to twist, being brittle, low hardness, and low precision.

Thus, the need for improvement still exists.

### SUMMARY OF THE INVENTION

It is therefore one object of the invention to provide a process of manufacturing a drive shaft of an explosion-proof motor, the drive shaft having a cylindrical section and a spline section, the process comprising the steps of horizontally disposing the drive shaft; continuously forward moving the drive shaft; feeding both a milling cutter and a correction roller toward the drive shaft wherein the correction roller is coaxial with a shaft of a lathe; activating the milling cutter to mill a front end of the drive shaft; and activating the correction roller to correct any deformations generated by the milling.

Preferably, the correction roller is made of diamond.

Preferably, the cylindrical section has a deformation of less than 0.02 mm per 200 mm of length, and the spline section has a deformation of less than 0.02 mm per 250 mm of length.

Preferably, the cylindrical section is made of number 45 carbon steel, the spline section is made of 17-4 stainless steel, and the spline section has a hardness of Rockwell Hardness C scale (HRC) 35-40.

The above and other objects, features and advantages of the invention will become apparent from the following detailed description taken with the accompanying drawings.

### BRIEF DESCRIPTION OF THE DRAWINGS

FIG. 1 is a perspective view of a drive shaft of an explosion-proof motor made by a process of manufacturing a drive shaft of an explosion-proof motor according to the invention.

### DETAILED DESCRIPTION OF THE INVENTION

Rotating speed of a drive shaft of an electric motor has increased to about 100,000 rotations per minutes as technologies make progress. It is also understood that an excessive deflection of the drive shaft may generate great noise and heat, and even break the motor. Conventionally, elongated drive shaft having an increased torque output is implemented. However, this can greatly increase the difficulties of manufacturing the drive shaft of an explosion-proof motor. Fortunately, a drive shaft of an explosion-proof motor manufactured by a process of the invention illustrated below solves all problems associated with the conventional drive shaft of an explosion-proof motor.

A process of manufacturing a drive shaft of an explosion-proof motor in accordance with the invention comprises the steps of horizontally disposing a drive shaft having a cylindrical section and a spline section; continuously forward moving the drive shaft; feeding both a milling cutter and a correction roller toward the drive shaft wherein the correction roller is coaxial with a shaft of a lathe; activating the milling cutter to mill a front end of the drive shaft; and activating the correction roller to correct any deformations generated by the milling. As an end, a finished drive shaft is obtained. It is noted that the correction roller is the characteristic of the invention.

Preferably, the correction roller is made of diamond.

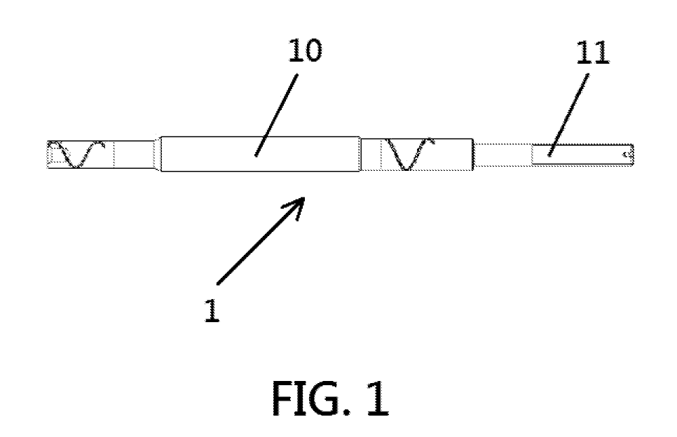

Referring to FIG. 1, a drive shaft made by above manufacturing process is designated 1 and comprises a cylindrical section 10 and a spline section 11. The cylindrical section 10 has a deformation of less than 0.02 mm per 200 mm of length, and the spline section 11 has a deformation of less than 0.02 mm per 250 mm of length. As a comparison, a drive shaft made by a conventional manufacturing process has a deformation of 0.3 mm per 200 mm of length. It is thus evident that precision of the drive shaft 1 of the invention is much higher than that of the conventional drive shaft. Preferably, the cylindrical section 10 is made of number 45 carbon steel, the spline section 11 is made of 17-4 stainless steel, and the spline section 11 has a hardness of Rockwell Hardness C scale (HRC) 35-40.

While the invention has been described in terms of preferred embodiments, those skilled in the art will recognize that the invention can be practiced with modifications within the spirit and scope of the appended claims.

What is claimed is:

1. A process of manufacturing a drive shaft of an explosion-proof motor, the drive shaft having a cylindrical section and a spline section, the process comprising the steps of:
horizontally disposing the drive shaft;
continuously forward moving the drive shaft;
feeding both a milling cutter and a correction roller toward the drive shaft wherein the correction roller is coaxial with a shaft of a lathe;
activating the milling cutter to mill a front end of the drive shaft; and
activating the correction roller to correct any deformations generated by the milling.

2. The process of claim 1, wherein the correction roller is made of diamond.

3. The process of claim 1, wherein the cylindrical section has a deformation of less than 0.02 mm per 200 mm of length, and the spline section has a deformation of less than 0.02 mm per 250 mm of length.

4. The process of claim 1, wherein the cylindrical section is made of number 45 carbon steel, the spline section is made of 17-4 stainless steel, and the spline section has a hardness of Rockwell Hardness C scale (HRC) 35-40.
